(19) United States
(12) Patent Application Publication
(10) Pub. No.: US 2024/0299906 A1
(43) Pub. Date: Sep. 12, 2024

(54) COIR PITH COMPOSITION WITH IMPROVED LIQUID ABSORPTION EFFICIENCY AND METHOD OF PREPARATION THEREOF

(71) Applicant: DEEPTHI ORGANICS LLC, Greensboro, NC (US)

(72) Inventors: Sundararaj Subramaniam, Greensboro, NC (US); Uma P. Jejurkar, Summerfield, NC (US)

(21) Appl. No.: 18/119,163

(22) Filed: Mar. 8, 2023

(51) Int. Cl. B01J 20/24; B01J 20/28; B01J 20/30

(52) U.S. Cl. CPC B01J 20/24; B01J 20/28016; B01J 20/3078; B01J 20/3085; B01J 2220/485

(57) ABSTRACT

The disclosure provides a method for enhancing liquid absorption capacity and usability of coir pith. The method includes providing dry coir pith, screening the coir pith with predetermined particle size, pasteurizing the coir pith using dry heat followed by moisturizing by mixing a moisturizing solution prepared by mixing distilled water with an antifungal agent or pasteurizing the coir pith using steam. The disclosed method is an organic process for cleaning up liquid spills. The method implements coir pith with particle size 1.0 mm or less in absorbing liquid spills, in a cost-effective and environmentally friendly manner. The disclosure further includes a coir pith composition with enhanced liquid absorption capacity of 0.5-0.6 mL of liquid per mL volume of the coir pith.

### CROSS-REFERENCES TO RELATED APPLICATIONS

None.

### FIELD OF THE INVENTION

The present invention generally relates to absorbent materials and more particularly relates to absorbent formulations with coir pith and method of preparing formulation with improved liquid absorption efficiency.

### BACKGROUND OF THE RELATED ART

Toxic compounds found in oil spills can have detrimental short- and long-term health consequences on oil workers, locals, marine life, animals, and the environment. Hazardous chemicals are released into the nearby water and land as soon as an oil spill occurs. It is challenging to clean up any oil spill. Skimmers and sorbents are used by workers to absorb oil after some of it has been skimmed off. Another choice is to mix dangerous, massive slicks of floating oil with water by dissolving them in chemicals.

The coir pith, also referred to as coco peat or coco coir, is commonly known for its application as an organic substrate in plant growth media. The use of coir pith as an absorber of spills of various types has been known for some time, although not widely used. Various publications have attempted to address some challenges associated with absorption of spills using coir pith. For instance, WO2018013680A1 discloses an absorbent product useable as an absorbent material for cleaning spills or as a plant growth medium for improved moisture retention. US20040025422A1 discloses a pellet formed from coconut coir that can be used for a variety of purposes including absorbing spilled liquids, as an animal litter, as a soil conditioner and as a seed carrier, growth medium. US20050028839A1 discloses a method for treating fluid spills on a surface such as a roadway, shop, garage, or worksite includes placing a biodegradable absorbent material, such as coconut coir, onto the spill. US20170050169A1 discloses an absorption medium, comprising compressed coir particles having been compressed from an uncompressed state at a volume to volume ratio of greater than 3:1, but less than 15:1, and having been ground to a grind size of 1/25 inches to ½.

However, the natural composition of coir pith includes particles as small as fine powder and as large as 8 mm. Using coir pith as is as an absorbent material compromises not only absorption effectiveness of the coir pith but also its usability, since, the fine particles pose a serious issue with dustiness especially in typical work situations like auto repair shops and factory floors. Moreover, fabrication of the above-mentioned coir products involves employment of complex mechanical processes at some point.

Hence, there has been a need in the art for a method for enhancing liquid absorption capacity of coir pith that is easy to implement, environmental friendly, cost effective and efficient in terms of improving usability of coir pith as a liquid absorbent. In this regard, the method and coir pith composition according to the present invention substantially departs from the conventional concepts and designs of the prior art.

These and other advantages will be more readily understood by referring to the following detailed description disclosed hereinafter with reference to the accompanying drawing and which are generally applicable to other systems and methods for recovering text legibility to fulfill particular application illustrated hereinafter.

### SUMMARY OF THE INVENTION

According to embodiments of the present subject matter, methods for enhancing liquid absorption capacity and usability of coir pith for use as a liquid absorbent are disclosed. In various embodiments, the method comprising the steps of providing dried coir pith, screening the coir pith with predetermined particle size; and pasteurizing and moisturizing the coir pith, thereby forming pasteurized coir pith having enhanced liquid absorption capacity and reduced fungal activity. In some embodiments, the pasteurizing comprises pasteurizing using dry heat and moisturizing by mixing a moisturizing solution comprising water at 40-60% by weight of the coir pith to obtain moisture-infused coir pith, wherein reducing fungal spores in the coir pith comprises mixing distilled water with an antifungal agent to form the moisturizing solution. In other embodiments, the pasteurizing comprises pasteurizing the coir pith using steam, thereby forming pasteurized and moisturized coir pith.

In various embodiments, the dry heat pasteurization may comprise heating the coir pith to 120° C.-450° C. In one embodiment, the dry heating includes heating the coir pith to 120° C. for 30 minutes. In another embodiment, the dry heating includes dry heating the coir pith at 450° C. for 5-10 seconds.

In various embodiments, the pasteurization with steam comprises passing the steam through the coir pith at 105° C. to 120° C. for 15-20 minutes at a pressure in the range 5 to 10 Kg/cm².

In various embodiments, the antifungal agent is mixed at a concentration of 10% or less in distilled water to obtain a moisturizing solution. In another embodiment, the antifungal agent includes at least one of calcium propionate, glucono delta lactone, sodium benzoate, potassium sorbate or a combination thereof at a concentration of 10% or less by weight of the distilled water.

According to another embodiment of the present subject matter, a coir pith composition with enhanced liquid absorbent capacity, storage and handling characteristics is disclosed. In various embodiments, the coir pith composition comprises dry coir with a predetermined particle size of 1 mm or less, and moisture content of 40-60% by weight. In various embodiments, the coir pith is configured to absorb 0.5-0.6 mL of liquid per mL volume of the coir pith.

In another embodiment, the predetermined particle size of coir pith in the composition is 0.4 mm or less.

In various embodiments, the antifungal agent is mixed with distilled water at a concentration of 10% or less by weight of the distilled water.

This and other aspects are disclosed herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1: represents a method for preparing coir pith based liquid absorbent with enhanced absorption efficiency.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The present subject matter discloses an improved coir pith composition with enhanced liquid absorption capacity and methods of producing the same. The product is configured to have improved handling characteristics for storage and use, in addition to exhibiting enhanced absorption characteristics for handling liquid spills.

The invention in various embodiments includes a coir pith composition with enhanced liquid absorbent capacity. The composition includes coir pith with predetermined particle size and controlled moisture content. In various embodiments, the coir pith composition includes a predetermined particle size of 1.0 mm or less. In another embodiment, the coir pith composition includes a predetermined particle size of 0.4 mm or less. In various embodiments, the coir pith composition includes moisture content of 40-60% by weight of the coir pith. The composition is configured to be treated so as to minimize the presence of fungal spores during storage or use. In some embodiments, the moisture content may be configured to be dependent on the particle size, for instance, coarse—0.4-1 mm particles may be configured to carry 40% and fine particles may carry up to 60% moisture, as optimum.

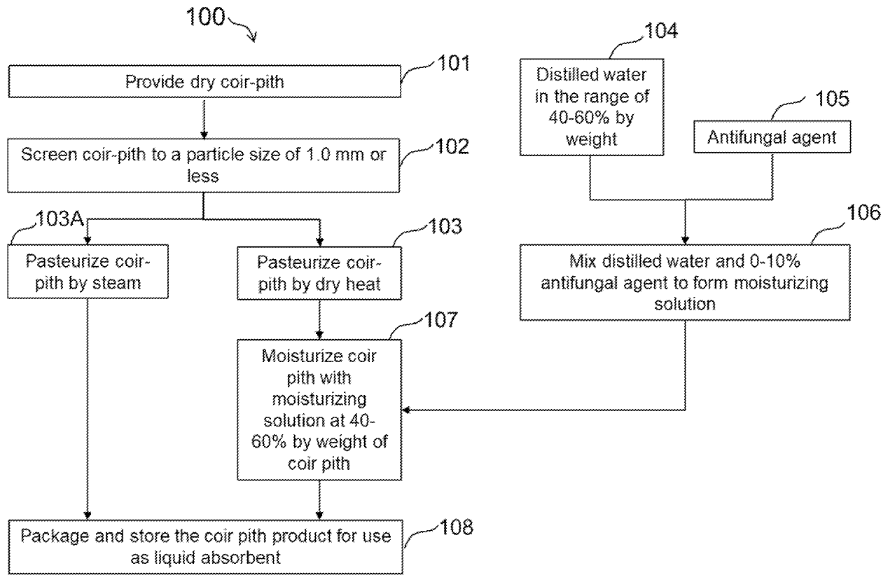

The invention in various embodiments includes a method of enhancing absorption capacity of coir pith 100. The method 100 involves various steps of enhancing liquid absorption capacity and usability of coir pith for use as a liquid absorbent as shown in FIG. 1. In step 101, dry coir pith is provided followed by screening in step 102 to produce particles of predetermined size. In various embodiments, the coir pith is screened in step 102 to be lower than a predetermined particle size. In various embodiments, the coir pith is screened to below 1.0 mm. In some embodiments, the coir pith is screened to have particle size 0.4 mm or less.

The next step involves pasteurization and moisturization in step 103-107 or 103A. In various embodiments, the pasteurizing is done by using dry heat in step 103, or using steam in step 103A. Step 103 may comprise heating the coir pith in the temperature range 120-450° C. for a predetermined time to achieve pasteurization. In one embodiment, the dry heating included heating the coir pith at 120° C. for 30 minutes. In another embodiment, the dry heating included heating the coir pith at 450° C. for 5-10 seconds. Although not specifically illustrated, the time at any temperature in the specified range may be proportionally varied. In various embodiments, the dry heating of coir pith is configured to provide a product with minimal fungal count.

In various embodiments, the pasteurizing using dry heat 103 includes uniformly heating the coir pith placed on conveyer belts or by passing through a suction mechanism or by using a stationary system. In various embodiments, the temperature for heating the coir pith is controlled by adjusting the heat source. The temperature of coir pith may be further controlled by adjusting the speed of the conveyors or power of the suction mechanism.

In various embodiments, the moisturizing after step 103 includes moisturizing the coir pith with moisturizing solution in step 107. In various embodiments, moisturizing the coir pith 107 includes mixing in step 106, distilled water 104 with an antifungal agent 105 to form a moisturizing solution. In various embodiments, the moisturizing solution is prepared prior to mixing with the coir pith of predetermined particle size to improve handling characteristics and remove the dustiness of the coir pith. In one embodiment, the moisturizing agent is configured to remove dustiness of the coir pith having particle size 0.4 mm or less. In various embodiments, the moisturizing solution may be water or distilled water 104. In another embodiment, the moisturizing solution may be made from a mixture of water 104 and antifungal agent 105. In various embodiments, the moisturizing solution includes water or distilled water. In various embodiments, the antifungal agent added to the water for moisturizing after dry heat pasteurization includes at least one of calcium propionate, glucono delta lactone, sodium benzoate, potassium sorbate or a combination thereof. In various embodiments, the antifungal agent is mixed at a concentration of 10% or less in distilled water to obtain a moisturizing solution. In one embodiment, the moisturizing solution includes calcium propionate at 8.7% by weight with respect to water.

In various embodiments, the pasteurizing using dry heat 103 includes the step 107 of adding the moisturizing solution to the pasteurized coir pith based on predetermined particle size to obtain moisture-infused coir pith. In various embodiments, the moisture-infused coir pith is prepared by mixing the coir pith with the moisturizing solution at 40-60% by weight of the coir pith 104. In various embodiments, adding the moisturizing solution to the pasteurized coir pith assists in reducing dustiness of the coir pith. In one embodiment, dry heat pasteurized coir pith with particle size of 0.4 mm or less and a moisture content of 40% by weight of the coir pith shows an absorption capacity of 0.69 ml/ml (volume of oil absorbed per unit volume of coir pith).

In various embodiments, the pasteurizing of the coir pith using steam 103A includes usage of steam for pasteurization, thereby forming pasteurized and moisturized coir pith. In various embodiments, pasteurization of coir pith using steam includes loading in a pressure container and pressurizing with steam at 105° C.-120° C. In some embodiments, the steam is pressurized for 15-20 minutes at a pressure in the range 5 to 10 Kg/cm². In one embodiment, the coir pith particle size 0.4 mm or less is loaded in a pressure container and steam at 120° C. is maintained at a pressure of 5-10 Kg/cm² for 20 minutes. In various embodiments, the method 100 includes packaging and storing 108 the moisture-infused coir pith for use as liquid absorbent.

In various embodiments, the method 100 and the coir pith composition disclosed address some of the drawbacks of conventional methods by implementing coir pith with particle size<0.4 mm (also known as ‘fines’) which is considered as waste and is excluded from the current applications of coir pith for potting soil and as a plant growing medium, thereby preserving the ecology. Further, in various embodiments, the method 100 and the composition of the present invention are experimentally validated and have cost efficiently demonstrated production of a liquid absorbent in an eco-friendly manner. In various embodiments, the method of the present invention provides lasting protection from fungal growth after the product has been packaged and during storage or transportation. In various embodiments, the coir pith with enhanced liquid absorbent capacity may be used directly in its moist condition.

In various embodiments, the coir pith composition with improved absorption capacity of the present invention is efficient for cleaning liquid spills which may include spills of oils, chemicals, paints. The composition of the present invention may be efficient for cleaning automotive oils, automotive fluids, lubricants, fuels, hydraulic fluids, drilling fluids, vegetable oils, used cooking oils, and the like. In various embodiments, the coir pith composition with improved absorption capacity of the invention is effective in cleaning liquid spills on land as well as water. The controlled moisture content of the coir pith produced by the inventive method is effective in reducing the dustiness of the fine coir pith. The moisture content may additionally provide weight for the particles to sit on the liquid to be absorbed, thereby enhancing efficiency of absorption.

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here and as delineated in the claims appended hereto.

### EXAMPLES

### Example 1: Evaluation of Optimum Particle Size of Coir Pith for Liquid Absorption

Coconut waste such as coir pith is widely available in tropical countries. Coconut waste was procured from the market. Experiments were performed to evaluate the absorption efficiency of different particle sizes of coir pith. Since the density of coir pith varies based on the particle size chosen, volume of oil absorbed per unit volume of coir pith was considered for the experiments. For the experiments, unscreened coir pith, coir pith screened for particle sizes 2.0-4.0 mm, 1.0-4.0 mm, 0.4-1.0 mm and less than 0.4 mm was considered. The unscreened coir pith included coir pith with a mix of different particle sizes naturally present in unprocessed coir pith.

To evaluate the absorption efficiency of different particle sizes of coir pith, 350 ml of coir pith (unscreened and screened) was placed in a tray and unused motor oil (SAW 5W20) was added to it in 20-30 ml increments until the provided coir pith was saturated and was unable to absorb any further quantity of oil. The oil absorption efficiency of coir pith with different particle sizes is represented in Table 1 below.

TABLE 1
Particle Size of Coir Pith versus Volume of Oil Absorbed

| | | | | | | Volume of |
|---|---|---|---|---|---|---|
| | | | | | | Oil |
| | | | | | | Absorbed |
| | | Volume | Weight | Volume | Weight | per unit |
| | | of coir | of coir | of oil | of oil | volume of |
| Particle Size (mm) | | pith | pith | absorbed | absorbed | Coir pith |
| UNSCREENED | | 350 ml | 39.4 g | 150 ml | 126 g | 0.43 ml/ml |
| COIR PITH | | | | | | |
| SCREENED | 2.0-4.0 | 350 ml | 28.07 g | 60 ml | 50.4 g | 0.17 ml/ml |
| COIR | 1.0-4.0 | 350 ml | 30.9 g | 90 ml | 75.6 g | 0.26 ml/ml |
| PITH | 0.4-1.0 | 350 ml | 39.83 g | 180 ml | 151.2 g | 0.51 ml/ml |
| | <0.4 | 350 ml | 56.55 g | 240 ml | 201.6 g | 0.69 ml/ml |
| | (Fines) | | | | | |

From the experiments, it was observed that coir pith with particle size 0.4 mm or less (also known as ‘fines’) show maximum oil absorption efficiency as compared to the unscreened and other screen particle sized coir pith and hence was considered for further experiments.

### Example 2: Determining the Optimum Moisture Level to Achieve Acceptable Dustiness of Coir Pith

A. Moisture level versus dustiness of coir pith: The use of coir pith with particle size<0.4 mm (fines) makes it difficult and inconvenient for use in a typical work environment, owing to its dustiness. Adding moisture to the fines reduces its dustiness. But since moisture occupies the capillary space in the coir pith particles, the absorption capacity of the coir pith is reduced. To overcome this situation, a set of experiments were performed to identify the optimum amount of moisture for removing dustiness of coir pith. For this purpose, samples of coir pith fines with various moisture percentages were prepared and compared subjectively for dustiness. Table 2 provides details on effect of different moisture levels on dustiness of the fines.

TABLE 2
Moisture Level versus Dustiness and
Other Characteristics of Coir Pith

| Moisture | | |
|---|---|---|
| % by wt | Dustiness | Appearance/Feel |
| 0% | Very dusty | Dry, Rough feel |
| 20% | Very dusty | Dry, Rough feel |
| 30% | Dusty | Dry, Rough feel |
| 40% | Barely Acceptable | Slightly Soft to feel |
| 50% | Non-dusty | Soft and Luxurious to feel |
| 60% | Non-dusty | Soft and luxurious to feel |

From the experiments, it was observed that a minimum of 40% moisture by weight to achieve an acceptable dustiness level.

B. Moisture level versus oil absorption capacity of coir pith: Experiments were carried out to determine the upper limit of moisture to achieve maximum oil absorption by coir pith. Oil absorption capacity of coir pith was analysed at various moisture levels. Unscreened coir pith with 0% moisture level was taken as reference for comparison of absorption since it represents the current state of the art for coir pith based liquid absorbents. Oil absorption was tested for coir pith fines (0.4 mm and less) at moisture levels of 40%, 50% and 60%. Table 3 represents oil absorption capacity of coir pith with particle size<0.4 mm at various moisture levels.

TABLE 3
Moisture Level versus Oil Absorption Capacity of
Coir Pith with Fine Particle Size 0.4 mm or Less

| | Volume of oil absorbed until | Volume of Oil Absorbed per | |
|---|---|---|---|
| Moisture % | saturation was reached | unit volume of Coir Pith | |
| 40% | 210 ml | 0.6 | ml/ml |
| 50% | 210 ml | 0.6 | ml/ml |
| 60% | 150 ml | 0.43 | ml/ml |

Oil absorption capacity was tested for coir pith particle size 0.4 mm-1.0 mm at moisture levels of 40%, 50% and 60%. Table 4 represents oil absorption capacity of coir pith with particle sizes ranging from 0.4-1.0 mm at various moisture levels.

TABLE 4
Moisture Level versus Oil Absorption Capacity of Coir
Pith with Coarse Particle Size 0.4 mm to 1.0 mm

| | Volume of oil absorbed until | Volume of Oil Absorbed per | |
|---|---|---|---|
| Moisture % | saturation was reached | unit volume of Coir Pith | |
| 40% | 180 ml | 0.51 | ml/ml |
| 50% | 180 ml | 0.51 | ml/ml |
| 60% | 150 ml | 0.43 | ml/ml |

From the experiments, it was observed that at 60% moisture the oil absorption capacity of the coir pith was same as that of unscreened coir pith (containing all particle sizes). However the material showed a soft and luxurious texture at moisture levels of 50% and 60% and was much less dusty.

### Example 3: Prevention of Fungal Growth in Moisture-Infused Coir Pith

Although introduction of moisture in coir pith fines helped in making the material non-dusty, it also made the material susceptible to mold/fungal growth when the coir pith was packed in a bag or container and kept in storage. Hence, fungal growth was prevented using pasteurization and/or anti-fungal agent. Pasteurization was achieved with the help of dry heat or using steam. The experiments were carried out on coir pith fines (having particle size 0.4 mm).

A. Dry heat pasteurization: During dry heat pasteurization, pasteurization using heat was carried out at 120° C. in an oven for 24 hrs. The temperature of the fines was controlled by adjusting the temperature of heat source Table 5 represents effect of heat pasteurization on the fungal growth in coir pith fines.

B Addition of anti-fungal agent: To further reduce fungal contamination or growth while moisturizing, an anti-fungal agent was added to the pasteurized fines. During this process, aqueous solution of calcium propionate was prepared and added to the fines. The same aqueous solution of calcium propionate was used to moisturize the fines and maintain a moisture level of 40%. Table 5 represents effect of aqueous solution of calcium propionate on the fungal growth in coir pith fines.

TABLE 5
Effect of Heat Pasteurization and/or Calcium Propionate
on Fungal Growth in Coir Pith Fines

| | Coir Peat | | | | | |
|---|---|---|---|---|---|---|
| Sr. | Particle size | Material | Equipment | Moisture | Calcium | Mold |
| No. | (mm) | Pasteurized | Sterilized | Added | propionate | Count^{#} |
| 1 | <4.0 | No | No | Yes | No | 150,000 |
| 2 | <4.0 | No | No | Yes | 1%* | 2,200 |
| 3 | <4.0 | Yes*** | No | Yes | No | 40 |
| 4 | <4.0 | Yes*** | Yes | Yes | No | <10 |
| 5 | <4.0 | Yes | No | No | No | 10 |
| 6 | <4.0 | Yes | No | No | No | 10 |
| 7 | <0.4 | Yes | No | No | No | 8,400 |
| 8 | <0.4 | Yes | No | Yes | 8.7%** | 250 |

(*1% by weight with respect to coir peat)
(**8.7% by weight with respect to water)
(***Heat sterilized in laboratory in an oven at 120° C. for 24 hrs)
^{#}Fungal count was measured in CFU/g per Test Protocol CMMEF 5^{th} ed. 21.51.

From the experiments it was observed that pasteurization was itself effective in controlling fungal growth. Addition of antifungal agent further assisted in reducing the mold count.

### Example 4: Preparation of Coir Pith Composition with Enhanced Liquid Absorbent Capacity

350 ml of dry coir pith screened for particle size 0.4 mm was taken in a container and pasteurized in the oven at a temperature of 120° C. A moisturizing solution containing calcium propionate and water was prepared wherein calcium propionate was taken 8.7% by weight of water. The moisturizing solution was added to the coir pith to maintain a moisture level of 40%. It was observed that 1 ml (per unit volume) of moisture-infused coir pith fines absorbed 0.69 ml unused motor oil (SAW 5W20).

What is claimed is:

1. A method for enhancing liquid absorption capacity and usability of coir pith for use as a liquid absorbent, the method comprising the steps of:
providing dried coir pith;
screening the coir pith with predetermined particle size; and
pasteurizing and moisturizing the coir pith, thereby forming pasteurized coir pith having enhanced liquid absorption capacity and reduced fungal activity therewithin, wherein the pasteurizing comprises
pasteurizing using dry heat and moisturizing by mixing a moisturizing solution comprising water at 40-60% by weight of the coir pith to obtain moisture-infused coir pith, wherein reducing fungal spores in the coir pith comprises mixing distilled water with an antifungal agent to form the moisturizing solution,
or
pasteurizing the coir pith using steam, thereby forming pasteurized and moisturized coir pith.

2. The method as claimed in claim 1, wherein the predetermined particle size of coir pith is 1.0 mm or less.

3. The method as claimed in claim 1, wherein the pasteurization comprises dry heating the coir pith to 120° C.-450° C.

4. The pasteurization as claimed in claim 3, wherein the dry heating includes heating the coir pith to 120° C. for 30 minutes or dry heating at 450° C. for 5-10 seconds.

5. The method as claimed in claim 1, wherein the pasteurization with steam comprises passing the steam through the moist coir pith at 105° C. to 120° C. for 15-20 minutes at a pressure in the range 5 to 10 Kg/cm².

6. The method as claimed in claim 1, wherein the antifungal agent is mixed at a concentration of 10% or less in distilled water to obtain a moisturizing solution.

7. The method as claimed in claim 1, wherein the antifungal agent includes at least one of calcium propionate, glucono delta lactone, sodium benzoate, potassium sorbate or a combination thereof at a concentration of 10% or less by weight of the distilled water.

8. A coir pith composition with enhanced liquid absorbent capacity, storage and handling characteristics, comprising coir pith with a predetermined particle size of 1 mm or less, and moisture content of 40-60% by weight.

9. The composition of claim 8, wherein the predetermined particle size is 0.4 mm or less.

10. The composition of claim 8, comprising an antifungal agent mixed with distilled water at a concentration of 10% or less by weight of the distilled water.

11. The composition of claim 8, wherein the coir pith is configured to absorb 0.5-0.6 mL of liquid per mL volume of the coir pith.
